(19) United States
(12) Patent Application Publication
(10) Pub. No.: US 2025/0272344 A1
(43) Pub. Date: Aug. 28, 2025

(54) PERSONAL SEARCH TAILORING

(71) Applicant: INTERNATIONAL BUSINESS MACHINES CORPORATION, Armonk, NY (US)

(72) Inventors: Su LIU, Austin, TX (US); Jun SU, Beijing (CN); Yu ZHU, Beijing (CN); Peng Hui JIANG, Beijing (CN); Guang Han SUI, Beijing (CN); Jun Feng DUAN, Beijing (CN)

(21) Appl. No.: 18/590,096

(22) Filed: Feb. 28, 2024

(51) Int. Cl. G06F 16/9535; G06F 16/2457; G06F 16/248

(52) U.S. Cl. CPC G06F 16/9535; G06F 16/24575; G06F 16/24578; G06F 16/248

(57) ABSTRACT

A computer-implemented method may include: monitoring historical query data comprising a search query and a search result; extracting, by the processor set, a user's real-time context; correlating, via a machine learning module, the user's real-time context to the historical query data; predicting, via the machine learning module, a user preference based on the correlating the user's real-time context to the historical query data; calculating a correlation score for the search result in a list of returned search results based on the user preference; re-ranking the search result in the list of returned search results based on the correlation score; and rendering a re-ranked search result as a second list of search results based on the re-ranking.

### BACKGROUND

Personalized and customized searching via web-browser search engines impact services such as customized message pushes, advertisement, video streaming, education, recommendations, etc.

### SUMMARY

In a first aspect of the invention, there is a computer-implemented method including: monitoring historical query data comprising a search query and a search result; extracting, by the processor set, a user's real-time context; correlating, via a machine learning module, the user's real-time context to the historical query data; predicting, via the machine learning module, a user preference based on the correlating the user's real-time context to the historical query data; calculating a correlation score for the search result in a list of returned search results based on the user preference; re-ranking the search result in the list of returned search results based on the correlation score; and rendering a re-ranked search result as a second list of search results based on the re-ranking.

In another aspect of the invention, there is a computer program product including one or more computer readable storage media having program instructions collectively stored on the one or more computer readable storage media. The program instructions are executable to: monitor historical query data comprising a search query and a search result; extract a user's real-time context; correlate, via a machine learning module, the user's real-time context to the historical query data; predict, via the machine learning module, a user preference based on the correlating the user's real-time context to the historical query data; calculate a correlation score for the search result in a list of returned search results based on the user preference; re-rank the search result in the list of returned search results based on the correlation score; and render a re-ranked search result as a second list of search results based on the re-ranking.

In another aspect of the invention, there is a system including a processor set, one or more computer readable storage media, and program instructions collectively stored on the one or more computer readable storage media. The program instructions are executable to: monitor historical query data comprising a search query and a search result; extract a user's real-time context; correlate, via a machine learning module, the user's real-time context to the historical query data; predict, via the machine learning module, a user preference based on the correlating the user's real-time context to the historical query data; calculate a correlation score for the search result in a list of returned search results based on the user preference; re-rank the search result in the list of returned search results based on the correlation score; and render a re-ranked search result as a second list of search results based on the re-ranking.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a block diagram of an exemplary environment in accordance with aspects of the present invention.

FIG. 4 shows a flowchart of an exemplary method in accordance with aspects of the present invention.

FIG. 5 shows a flowchart of an exemplary method in accordance with aspects of the present invention.

FIG. 6A shows a use case in accordance with aspects of the present invention.

FIG. 6B shows a use case in accordance with aspects of the present invention.

FIG. 7 shows a table of an exemplary environment in accordance with aspects of the present invention.

FIG. 8 shows a flowchart of an exemplary method in accordance with aspects of the present invention.

### DETAILED DESCRIPTION

Aspects of the present invention relate generally to personal search tailoring and, more particularly, to tailoring search results based on user search queries, search results, user preferences, and related contextual information. Aspects of the present invention may include using artificial intelligence (AI), human-computer interaction (HCI) data analysis, and the Internet of Things (IoT) to improve the manner in which searching occurs and how results are rendered to a user. In embodiments, the system dynamically tailors and re-ranks search results without providing a user's personal data to a search engine in order to ensure user privacy. In embodiments, the system may learn, via AI, machine learning (ML), or natural language processing (NLP), from a user's past behavior and search history to understand user's interests.

According to aspects of the invention, personally tailored searching may include using AI, including ML or NLP techniques, in real time to understand and interpret user queries and content within web pages. This may include tasks like sentiment analysis, entity recognition, and language translation. The system may perform HCI data analysis to examine how a user browses the web and interacts with content, providing insights into the user's preferences. The system may integrate IoT devices to provide and consider real-time context, taking into account user's current location and the time of day, making search results even more relevant. In this manner, implementations of the invention provide search results that are highly personalized and context-aware. AI-driven recommendations are complemented by real-time responsiveness to a user's location and time while keeping the user's data safe from a search engine. By cutting through information overload, providing efficient results, and respecting user's privacy, the system provides a user-centric, personalized, and privacy-conscious approach to online searching.

Aspects of the present invention include monitoring historical query data including search queries, search results, and related contextual information of a user during a search. Historical query data may further include search keywords, selected URLs in the list of returned search results daily web surfing history, real-time user interactions, social media account data, voice recordings, video recordings, and Internet of Things sensor data. In embodiments, the disclosed system may be installed locally on a computing device and integrated with a web browser as a plug-in or via an application programming interface (API) or similar integration. The system may include extracting a user's real-time context during a search, such as time and location. The system may include correlating the user's real-time context to historical query data such as previous related searches. As an example, historical query data regarding popular restaurants may be correlated to real-time search queries occurring during a time of day associated with eating, such as lunch or dinner time. The system may include predicting a user preference based on the correlating. The system may include selecting a re-ranking factor based on the correlating and calculating a correlation score for the search results in a list of returned pre-ranked search results. The system may include re-ranking the search result in the list of returned pre-ranked search results based on the correlation score. The system may include rendering, as user interface elements on a display of a computing device, a re-ranked search result as a second list of search results.

In embodiments, a computer-implemented method may include: monitoring historical query data including search queries and returned results and related contextual information on a human-computer interaction (HCI) level; extracting the user's real-time context during the search, including location and time; correlating the user's real-time context with historical data to understand the user's immediate needs; predicting user preferences and selecting required reranking factors (user's age, gender, family members and relations, personal preferences (colors, sizes, styles), search history, browsing behavior, and interaction patterns, etc.); analyzing each returned searching result entry in the returned uniform resource locator (URL) list to calculate the correlation score with the predicted user preferences; re-ranking the returned URL list and generate a recommended URL list according to the calculated correlation scores; and rendering the recommended URL list as the final returned search list in the user's browser.

In embodiments, the computer-implemented method may further include allowing administrators and users to configure and customize system settings including: targeted search engines, authentication, enable/disable system features, attributes of system data structure, and system criteria including tracked contextual items in day and related scopes; weights of reranking factors including user age, gender, family members and relations; personal preferences including colors, sizes, styles; search history, browsing behavior, interaction patterns. In embodiments, system criteria and related settings may be adjusted according to user feedback.

In embodiments, the computer-implemented method may further include collecting user searching activities including search keywords, focused URLs, and clicked URLs in the returned/reranked URL List. The data may be gathered from daily web surfing history, real-time users' interactions, social media accounts, voice/video recordings, IoT sensors, and other digital sources. The system may learn, via ML, AI, or NLP, user personal characteristics associated with interested areas under different contexts associated with the user's searching and clicking patterns and create and update a corresponding user profile.

In embodiments, the computer-implemented method may further include defining a framework to support a system including a personal search tailoring bot (PST-bot) on client-side systems. The method may further include defining a data structure for tracking and saving system data. System data may include user identification data, search word cloud lists, search words, correlated search words, contextual search data, returns URLs, rendered URLs, time, location, and activity data. The method may include: defining a plugin and/or application that can be installed in an application via API, such as a web-browser application, for tailoring and re-ranking general returned searching results according to analyzed HCI data; personalizing searching without embedding personal data in the searching requests; and protecting user privacy.

Traditional web searching, such as via a web-browser, creates a significant challenge for a user searching for specific, relevant information. Traditional search engines, while powerful, often fall short in delivering personalized and context-aware results. A user may frequently face challenges including information overload, lack of personalization, inadequate context awareness, disconnected user experience, static search rankings, and privacy concerns.

As a non-limiting example, a user may be searching in a traditional search engine for healthy recipes via a web browser that returns search results providing generic recipes that do not consider a user's specific dietary restrictions, past recipe search history, timing, or location. Preferably, search results would be intelligently tailored to provide healthy recipe options that align with the user's dietary preferences and past cooking habits without requiring the user to disclose personal information within the search query itself or to the search engine provider.

As another non-limiting example, a user may be searching in a traditional search engine for restaurants in a new city that they have previously not visited. A traditional search engine may return search results that do not account for the traveler's real-time location, cuisine preferences, or past dining history. Preferably, search results would be dynamically reranked to prioritize local restaurants that match the traveler's cuisine preferences and dining habits without requiring the user to disclose personal information within the search query itself or to the search engine provider.

As yet another non-limiting example, a user may search for shoes in a traditional search engine, and will receive search results displaying a wide range of shoe types and brands without considering the user's past shopping behavior, shoe size, or style preferences. Preferably, search results would be tailored to showcase shoes and align with the use of shoe size and style preferences, and past shopping history without requiring the user to disclose personal information within the search query itself or to the search engine provider.

As an additional non-limiting example, a user may search for news articles in a traditional search engine and receive search results providing generic news results that do not account for the user's interests, past news article views, or current location. Preferably, search results would be tailored to deliver news articles that align with the user's interests, past reading habits, and real-time location without requiring the user to disclose personal information within the search query itself or to the search engine provider.

Aspects of the present invention address conventional search problems by leveraging AI to create personalized search results tailored to each user's unique preferences, search history, and browsing behavior. This personalization significantly improves the relevance of search results. Aspects of the present invention address conventional search problems by integrating IoT data and real-time user context such that the system may provide search results that are sensitive to the user's present location and time, offering more relevant information for their immediate needs. Aspects of the present invention address conventional search problems because users benefit from faster and more efficient information retrieval as the system prioritizes content based on past interactions and present context, reducing the time spent sifting through irrelevant search results. Aspects of the present invention address conventional search problems via integration of HCI data analysis, ensuring that the system understands user behavior and interaction patterns. This leads to a more engaging and user-centric search experience, increasing user satisfaction. Aspects of the present invention address conventional search problems by not providing user data to search engines and adhering to data protection regulations, giving users more control over their data and addressing privacy concerns. Aspects of the present invention address conventional search problems by allowing users to adjust their behavior and control data-sharing preferences. This empowers users to tailor their search experience to their liking. Aspects of the present invention address conventional search problems by reducing irrelevant search results, reducing information overload, and making it easier to find the information a user seeks. Aspects of the present invention address conventional search problems by implementing a dynamic ranking algorithm that continually adapts to user behavior and feedback, ensuring more accurate results. Aspects of the present invention address conventional search problems by providing a user-centric approach, prioritizing the individual's preferences and immediate context, resulting in a more satisfactory and efficient search experience.

Implementations of the invention are necessarily rooted in computer technology and cannot be performed mentally. For example, correlating, via ML or NLP, the user's real-time context to historical query data and predicting, via ML or NLP, a user preference based on the correlating are computer-based and cannot be performed in the human mind. Training and using a machine learning model are, by definition, performed by a computer and cannot practically be performed in the human mind (or with pen and paper) due to the complexity and massive amounts of calculations involved. For example, an artificial neural network may have millions or even billions of weights that represent connections between nodes in different layers of the model. Values of these weights are adjusted, e.g., via backpropagation or stochastic gradient descent, when training the model and are utilized in calculations when using the trained model to generate an output in real time (or near real time). Given this scale and complexity, it is simply not possible for the human mind, or for a person using pen and paper, to perform the number of calculations involved in training and/or using ML or NLP.

It should be understood that, to the extent implementations of the invention collect, store, or employ personal information provided by, or obtained from, individuals (for example, location data, time data, personal characteristics, and personal preferences, etc.), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as personal search tailoring code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

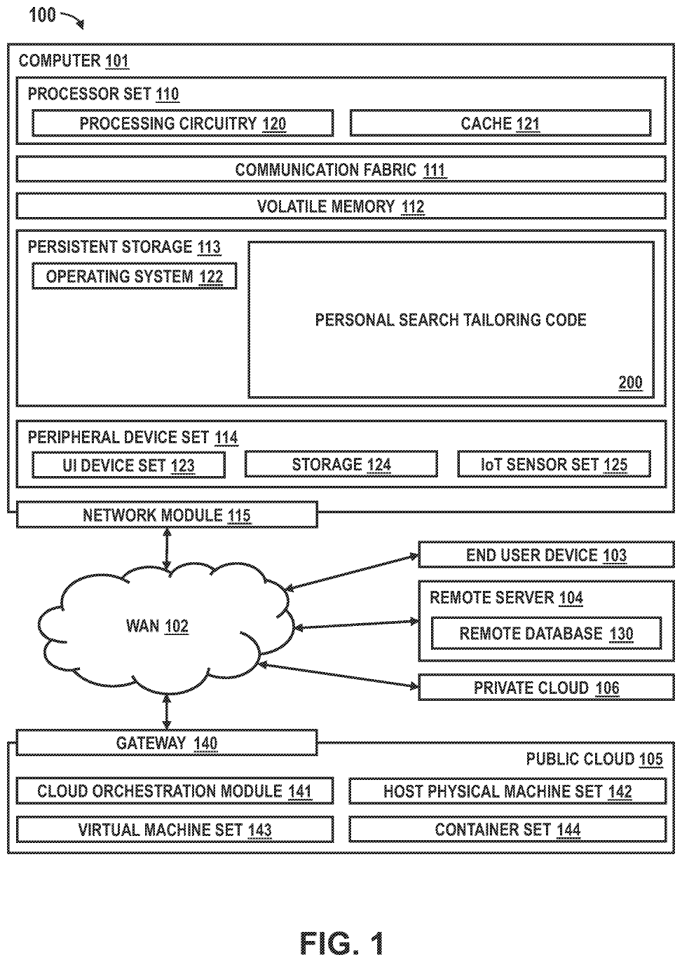

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

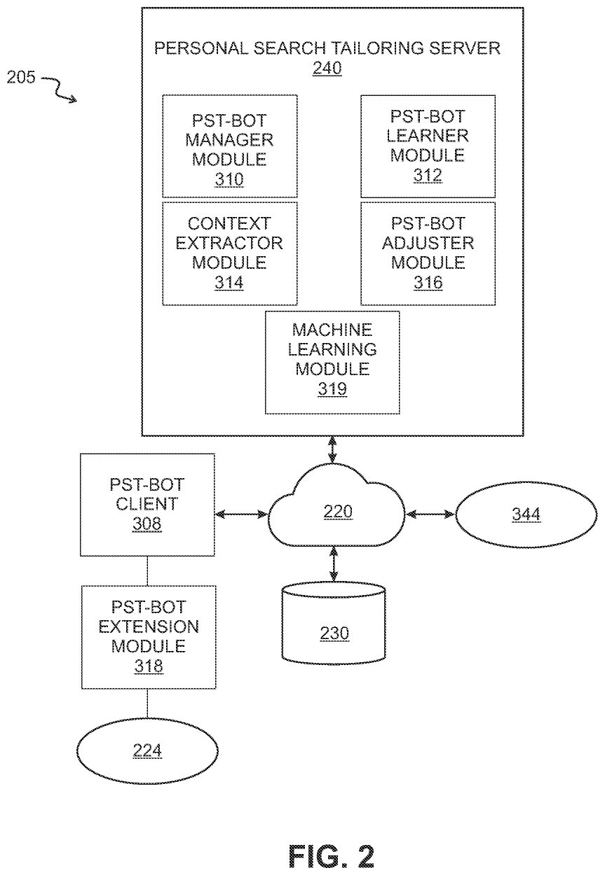

FIG. 2 shows a block diagram of an exemplary environment 205 in accordance with aspects of the invention. In embodiments, the environment includes personal search tailoring server 240, corresponding to computer 101 as in FIG. 1, including or in communication with modules including a PST-bot manager module 310, a PST-bot learner module 312, a context extractor module 314, a PST-bot adjuster module 316, and a machine learning module 319 corresponding to personal search tailoring code of block 200 of FIG. 1. The personal search tailoring server 240 may be configured for monitoring historical query data including search queries and results, extracting real-time context, correlating real-time context to historical query data, predicting user preferences, re-ranking and rendering re-rank search results to be communicated to a user computer device 224. The personal search tailoring server 240 may be in operable communication with a PST-bot client 308, including PST-bot extension module 318, which collectively performs actions on behalf of the personal search tailoring server 240 on the user computer device 224. PST-bot client 308, including PST-bot extension module 318, may be configured to provide access and use of services provided by the personal search tailoring server 240. The environment 205 includes at least one IoT sensor 344 corresponding to IoT sensor set 125 of FIG. 1 and a database 230 in operable communication with the personal search tailoring server 240 over network 220, corresponding to WAN 102 of FIG. 1. The database 230, corresponding to remote server 104 or remote database 130 of FIG. 1, may store user profile data, search query and results data, contextual data, preference data, correlation data, correlation score data, and re-ranking data, among other things.

In embodiments, the PST-bot manager module 310, a PST-bot learner module 312, a context extractor module 314, a PST-bot adjuster module 316, and machine learning module 319, each may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. The search tailoring server 240 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

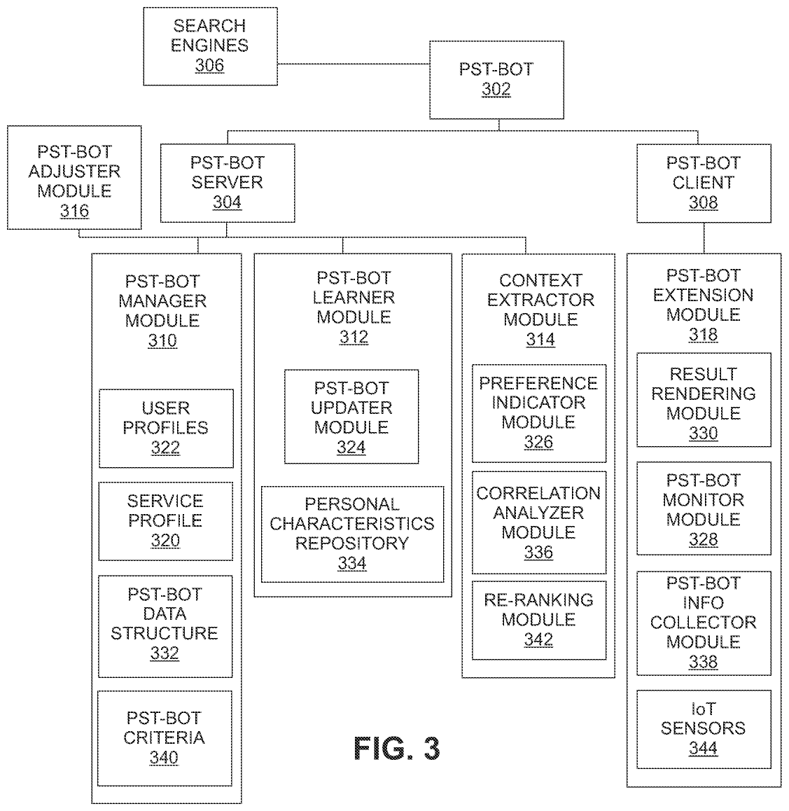

FIG. 3 shows a block diagram of an exemplary environment in accordance with aspects of the present invention. Steps of the method may be carried out in the environment of FIG. 2 and are described with reference to elements depicted in FIG. 2.

The system may comprise PST-bot 302 corresponding to the search tailoring server 240 of FIG. 2. In embodiments, the PST-bot 302 may be in operable communication with a PST-bot server 304, search engines 306, and a PST-bot client 308. The PST-bot server 304, PST-bot client 308, and a personal characteristics repository 334 may make up a framework to support the PST-bot 302 and may allow administrators 402 and users 404 to configure and customize settings, such as preferred search engines, authentication, and enabling or disabling system features. PST-bot server 304 may be a part of a server-side implementation of the system. PST-bot client 308 may be a part of a client-side implementation of the system, including PST-bot extension module 318, such as a plug-in, add-on, or application installed on a user computing device like a smartphone, such as user computer device 224 of FIG. 2.

PST-bot 302 may include any number of modules in the description of FIG. 2, such as the PST-bot manager module 310, the PST-bot learner module 312, the context extractor module 314, and the PST-bot adjuster module 316. The PST-bot manager module 310 may function as a user interface manager and may store service profiles 320 and user profiles 322 in a database such as the database 230 of FIG. 2. Service profile 320 may include PST-bot data structure 332 and PST-bot criteria 340. The PST-bot data structure 332 may include search words, correlated words, word search cloud lists, and weights applied to words within the word search cloud list. In some embodiments, the PST-bot data structure 332 uses a word frequency algorithm to identify contextual data or user preferences. PST-bot criteria 340 may include tracked contextual items in day and related scopes, weights of reranking factors including: user's age, gender, family members and relations; personal preferences including: colors, sizes, styles; and search history, browsing behavior, interaction patterns, etc. The PST-bot learner module 312 may include a PST-bot updater module 324 and a personal characteristics repository 334 that may be a part of the database 230 of FIG. 2. The PST-bot learner module 312 may collect user search activities such as search keywords, focused and selected URLs, and the like as HCI data stored in the personal characteristics repository 334. The HCI data may be gathered from daily web surfing history, real-time user interactions, social media accounts, video or voice recordings, IoT sensors 344 of FIG. 2, and other sources. The PST-bot learner module 312 may learn user personal characteristics associated with interested topics under different context associated with the user's searching and selection. The PST-bot learner module 312 may implement ML or NLP to identify HCI data and learn personal characteristics from search queries, historical search data, or the personal characteristics repository 334. Personal characteristics may be learned from HCI data via ML or NLP by semantic analysis of text inputs to determine the meaning of text inputs and the relationships between words, phrases, and sentences. Personal characteristics may be learned via text input analysis to extract information regarding language patterns, sentiment, and interest. Sentiment analysis may include inferring relationships between topics based on social activity such as views, “likes,” comments, etc. NLP may also include topic modeling of topics frequently engaged with including search queries, comments, reviews, etc. As a non-limiting example of learning personal characteristics, user search queries may include “running shoes” and “local marathon schedule” to learn that a user is training for a marathon in the city in which they are currently located. HCI data and learned personal characteristics may be used to create and update user profiles 322 via the PST-bot updater module 324. In embodiments, a user profile may be determined based on search queries, search results, historical query data, and real-time context and may periodically updated with predicted user preferences. In this manner, embodiments may be configured to determine a user profile based on the search query, the search result, the historical query data, and the real-time context and update the user profile based on the user preference. HCI data and learned personal characteristics may be stored in the personal characteristics repository 334.

The context extractor module 314 may include a preference indicator module 326, a correlation analyzer module 336, and a re-ranking module 342. The context extractor module 314 may be configured to extract a user's real-time context during a search query, and which is distinct from the search query itself, including location and time data, and correlate real-time context data with historical data to identify users' immediate needs. Extracting a user's real-time context via the context extractor module 314 may include gathering computing device time and location data. Correlating the user's real-time context to a historical query data to identify users' immediate needs via the correlation analyzer module 336 may occur via word correlation, ML or NLP performed by the machine learning module 319 of FIG. 3. The preference indicator module 326 may be configured to predict user preferences and select re-ranking factors such as a user's age, gender, family members and relations, style preferences, search history, browsing behavior, and interaction patterns. User preferences may be predicted via NLP of data within user profiles 322 or personal characteristics stored in the personal characteristics repository 334. Correlation analyzer module 336 may analyze returned search results from a search query within a returned URL list to identify search words and contextual information and calculate a correlation score based on the predicted user preferences from the preference indicator module 326 compared to returned search results.

The PST-bot adjuster module 316 may be configured to adjust PST-bot criteria 340 and related settings according to user feedback, such as adjusting the re-ranking of search results based on user interaction with rendered results. For example, the PST-bot adjuster module 316 may be configured to receive user feedback to deemphasize or further emphasize certain real-time context data, such as a user's age, gender, family members and relations, personal preferences, search history, browsing behavior, location data, time data, and human-computer interaction patterns. User feedback may be received, as a non-limiting example, via togglable choices or options within a user settings menu. PST-bot adjuster module 316 may instruct the PST-bot learner module 312 or preference indicator module 326 to modify re-ranking factors based on user feedback.

The PST-bot extension module 318 may include a PST-bot monitor module 328 and a result rendering agent module 330. The PST-bot monitor module 328 may include a PST-bot information collector module 338, and IoT sensors 344, both of which may be configured to monitor search activities including historical search queries and research results as well as related contextual information gathered or learned by the PST-bot learner module 312 and stored in the personal characteristics repository 334. The PST-bot information collector module 338 may be in operable communication with the IoT sensors 344, such as biomedical sensors, accelerometers, gyroscopes, cameras, temperature sensors, etc., in operable communication with the user computer device 224, wherein the PST-bot information collector module 338 collects data that may include biomedical data, location data, time data, etc., with respect to the user computer device 224. The PST-bot monitor module 328 may monitor historical query data, including search activities, including using a web history crawler, retrieving data from a user device, including keyboard inputs and device inputs, or using a search history crawler configured to collect user data. In this manner, embodiments may be configured to monitor historical query data comprising a search query and a search result. The IoT sensors 344 may include any number of sensors within a user device or in operable communication with a user device, such as over a WAN 102 of FIG. 1 and WAN 202 of FIG. 2. The PST-bot extension module 318 may be a plugin or application that can be installed within another application, such as a web browser application, to facilitate tailoring and re-ranking general return search results according to analyzed HCI data and personalizing the searching without embedding personal data within search query requests. In this manner, embodiments may be configured to perform search functions that consider user preferences wherein a search query does not include personal data of a user. The result rendering agent module 330 may render recommended search results and a re-ranked, rendered URL list as a final return search list in the user's web browser.

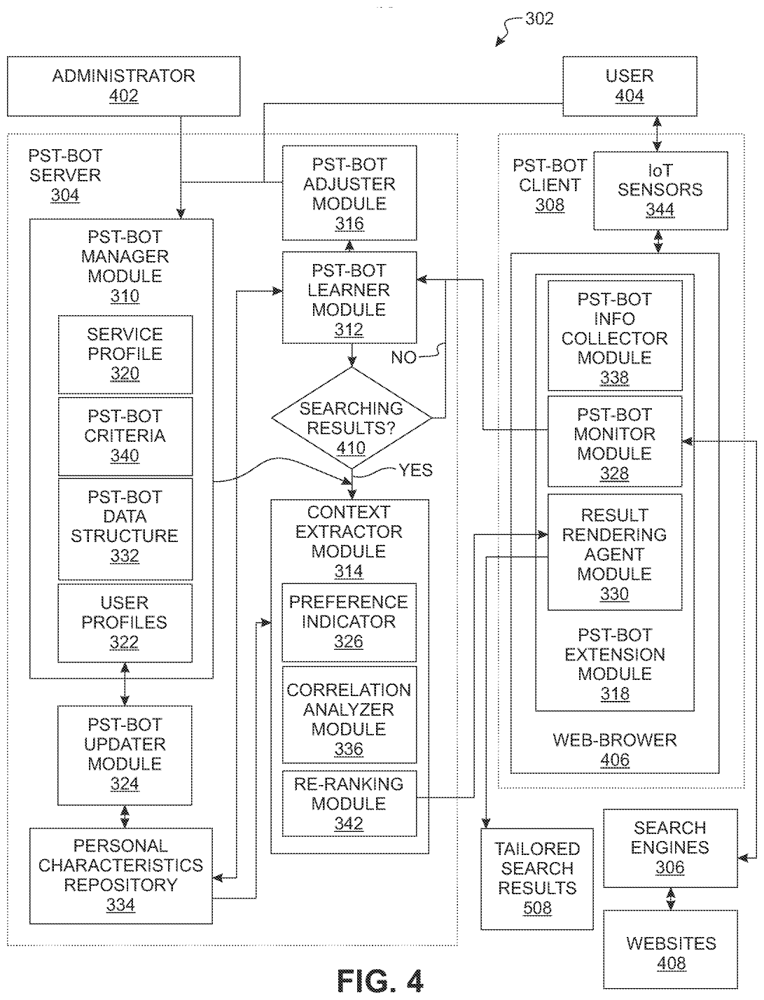

FIG. 4 shows a flowchart of an exemplary method in accordance with aspects of the present invention. A user 404 may interact with the PST-bot client 308 via user computing device 224, which may include each of the IoT sensors 344, the PST-bot information collector module 338, PST-bot monitor module 328, and the result rendering agent module 330, which may make up the PST-bot extension module 318 implemented within a web browser 406 of the PST-bot client 308 on a user computer device 224. PST-bot client 308 may be a software application installed on the user computer device 224 and may facilitate communication between the PST-bot extension module 318 and the web browser 406. For example, PST-bot extension module 318 may submit user queries to search engines 306 via the web browser 406 and receive returned search results. The PST-bot monitor module 328 may monitor user 404 historical query data including search queries within a search engine 306 that may return search query results from websites 408. Search query results may be communicated from the PST-bot monitor module 328 to the PST-bot learner module 312 of a PST-bot server 304. The PST-bot learner module 312 may receive search results 410 from search engines 306 via the PST-bot monitor 328. The PST-bot manager module 310, including a service profile 320, PST-bot criteria 340, PST-bot data structure 332, and user profiles 322, may provide a service profile, data structure, criteria, and user profile information to the context extractor module 314. The context extractor module 314 may extract a user's real-time context during a search query, including location and time data. Extracting a user's real-time context via the context extractor module 314 may include gathering computing device time and location data. In this manner, embodiments may be configured to extract a user's real time context. The preference indicator module 326 may be configured to predict user preferences performed by the machine learning module 319 implementing ML or NLP to perform sentiment analysis, topic modeling, user profiling, collaborative filtering, or similar techniques on a user's real-time context or historical query data. Predicting user preferences may include learning, via natural language processing, a user's personal characteristics associated with topics under different contexts associated with the user's searching and clicking patterns. In this manner, embodiments may be configured to predict a user preference based on a user's real-time context or historical query data. The preference indicator module 326 may be configured to select re-ranking factors such as a user's age, gender, family members and relations, style preferences, search history, browsing behavior, and interaction patterns received from the personal characteristics repository 334. Re-ranking factors may be selected via NLP based on their relevance to user preferences. User preferences may be predicted via NLP of data within user profiles 322 or personal characteristics stored in the personal characteristics repository 334. User preferences may be predicted via NLP of data within user profiles 322 or personal characteristics stored in the personal characteristics repository 334. Re-ranking factors may be used to re-rank search results from a search query within a returned URL list based on the correlation score. Correlation analyzer module 336 may analyze, via ML or NLP, returned search results from a search query within a returned URL list, provided by the search engines 306, to identify search words and contextual information and correlate the user's real-time context to historical query data. Correlating real-time context to historical query data may include comparing contextual data such as location and time to historical query data such as keyword searches to identify patterns in a user's behavior and preferences with respect to specific times and locations. Correlating the user's real-time context to historical query data to identify the user's immediate needs via the correlation analyzer module 336 may occur via word correlation, ML, or NLP performed by the machine learning module 319 of FIG. 3. Correlating may include analyzing, via the machine learning module 319 of FIG. 3, how often words within text appear together or in proximity to one another to identify patterns of word association, co-occurrence between words, and semantic similarities. In this manner, embodiments may be configured to correlate a user's real-time context to a historical query data. The correlation analyzer module 336 may calculate a correlation score indicative of the relevance of search words and contextual information compared to the predicted user preferences from the preference indicator module 326. That is, the correlation score may be calculated based on similarities between the search words and contextual information and the predicted user preferences where a high correlation score may be indicative of high similarity between a search query, contextual information, and predicted user preferences. As an example, a search query for “athletic shoes” may be compared to predicted user preferences for a user with predicted user preferences related to marathon running to determine a correlation score indicative of high-relevance search results relating to both shoes and marathon running. In this manner, embodiments may be configured to calculate a correlation score for the search result in a list of returned search results.

A re-ranking module 342 may re-rank search results from a search query within a returned URL list based on the correlation score. This may include re-ordering search results within a list based on their relevance to the user as indicated by the correlation score. In this manner, embodiments may be configured to re-rank search results in a list of returned search results based on the correlation score. Re-ranked search results may be communicated to the result rendering agent module 330, which may render and display, as user interface elements on the user computer device 224, tailored search results 508. In this manner, embodiments may be configured to render a re-ranked search result as a second list of search results.

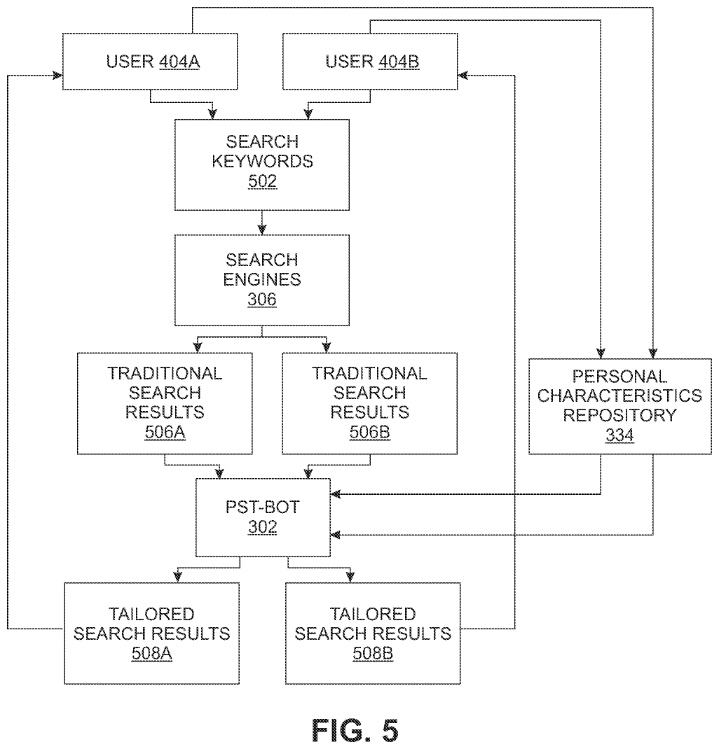

FIG. 5 shows a flowchart of an exemplary method in accordance with aspects of the present invention. User 404A and 404B, corresponding to user 404 of FIG. 4, may be two individuals searching for specific items or information on a search engines 306 via search keywords 502. User 404A may be an 18-year old male named Peter searching for athletic shoes via the search engines 306, which may be personal characteristics learned by the PST-bot learner module 312 and stored in the personal characteristics repository 334. User 404A may receive traditional search results 506A via the search engine 306 and which are search keyword 502 dependent without considering user's 404A personal characteristics, such as style preferences and shopping habits, which may be stored in personal characteristics repository 334. Similarly, User 404B may be a 40-year old female named Lisa with one daughter searching for casual shoes via the search engines 306. User 404B may receive traditional search results 506B via the search engine 306, such as in a first search results list, and which are search keyword 502 dependent without considering user's 404A personal characteristics, such as previous search history or user 404B's daughter, as determined by the PST-bot learner module 312 and stored in the personal characteristics repository 334. Traditional search results 506A and 506B may be input into the PST-bot 302 corresponding to the search tailoring server 240 of FIG. 2 to create tailored search results 508A and 508B corresponding to user 404A and 404B, respectively. PST-bot 302 may dynamically tailor and re-rank traditional search results 506A, 506B based on personal characteristics stored in the personal characteristics repository 334 into tailored search results 508A and 508B as depicted in FIG. 3 and FIG. 4, such as in a second list, without providing the user's personal data to the search engines 306 in order to ensure user privacy.

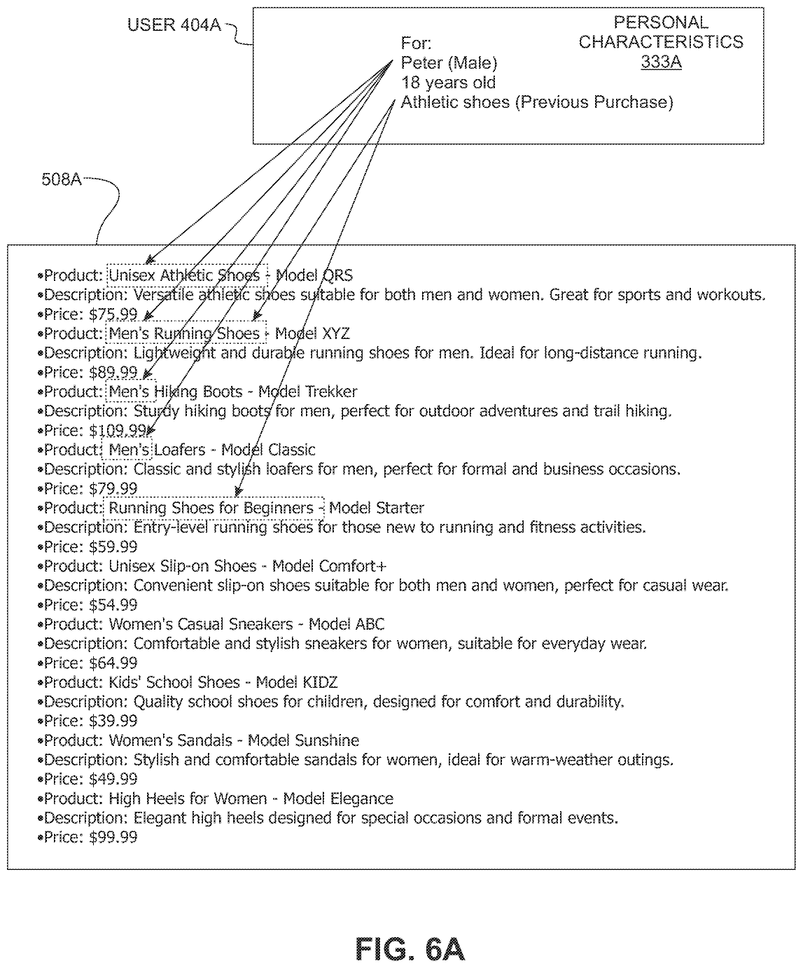

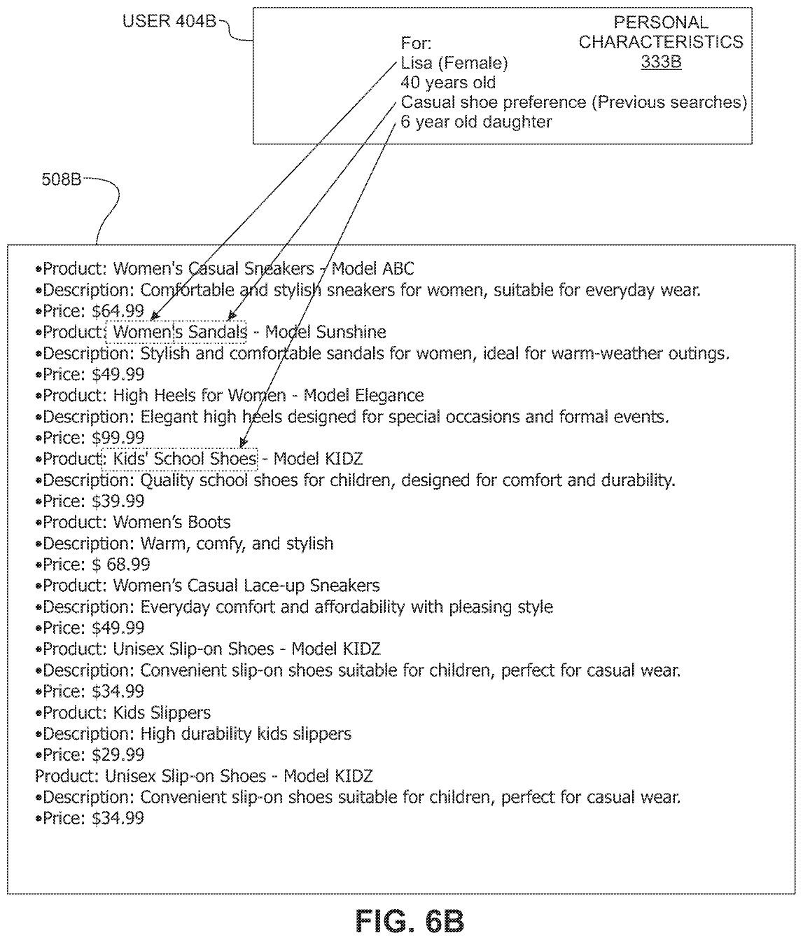

FIG. 6A shows a block diagram of an exemplary use case of the method of FIG. 5, in accordance with aspects of the present invention, including tailored search results 508A based on personal characteristics 333A of user 404A of FIG. 5, wherein the personal characteristics 333A are received from the personal characteristics repository 334 of FIG. 5. In embodiments, tailored search results 508A may also be based on the user profile 322 of FIG. 3, including historical search queries, clicks, and other HCI data. Tailored search results 508A may be adjusted by re-calculating the correlation score for the search results in a list of returned search results based on the user profile and re-rank the traditional search results 506A of FIG. 5 into tailored search results 508A. In embodiments, tailored search results 508A may be adjusted again by re-calculating the correlation score and re-ranking the tailored search results 508A. Personal characteristics 333A may be used to tailor and re-rank traditional search results 506A of FIG. 5 into tailored search results 508A. As a non-limiting example, user 404A “Peter” searches for “shoes” and PST-bot 302 may tailor search results 508A to include information relating to user 404A's personal characteristics, such as style preferences and shopping habits, which is information received from the personal characteristics repository 334 of FIG. 5, but which was not input as part of a keyword search, such as the search keywords 502 of FIG. 5.

FIG. 6B shows a block diagram of another exemplary use case of the method of FIG. 5 in accordance with aspects of the present invention, including tailored search results 508B based on personal characteristics 333B of user 404B, wherein the personal characteristics 333B are received from the personal characteristics repository 334 of FIG. 5. Personal characteristics 333B may be used to tailor and re-rank traditional search results 506B of FIG. 5 into tailored search results 508B. As a non-limiting example, user 404B “Lisa” searches for “shoes” and PST-bot 302 may tailor search results 508B to include information relating to user 404B's 6-year-old daughter, which is information received from the personal characteristics repository 334 of FIG. 5, but which was not input as part of a keyword search, such as the search keywords 502 of FIG. 5.

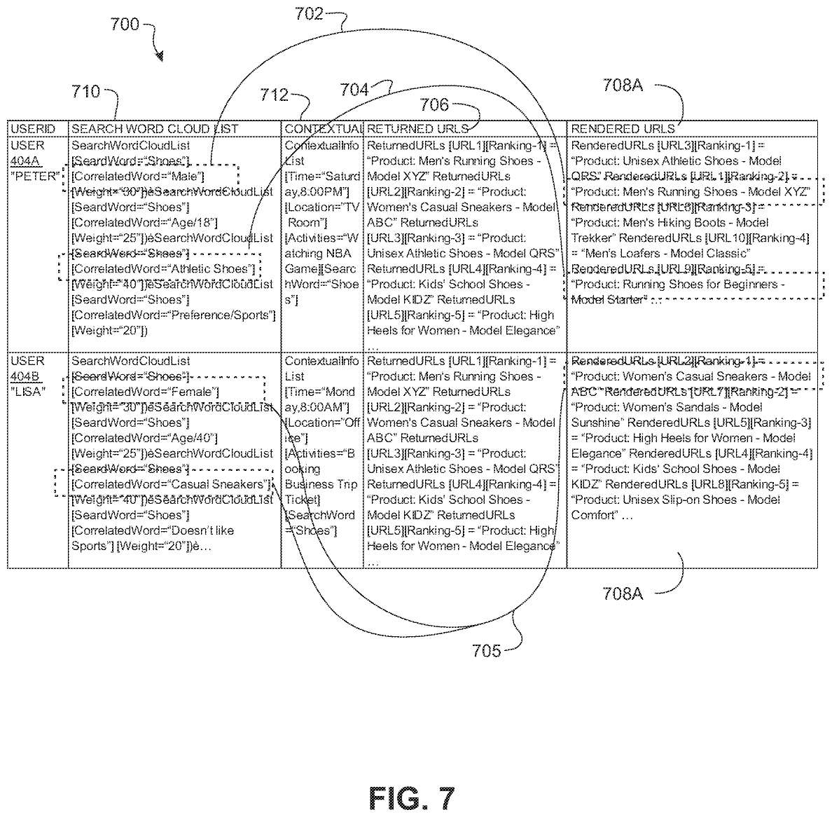

FIG. 7 shows a table of an exemplary environment 700 in accordance with aspects of the present invention, including re-ranking of returned URLs 706 as rendered URLs 708 based on search words 710 and contextual information 712. User 404A, “Peter,” may input search keywords 702, 704, 705 corresponding to search keywords 502 of FIG. 5, such as “male” and “athletic shoes,” and the system may re-rank returned URLs 706A, corresponding to traditional search results 506A of FIG. 5, as rendered URLs 708. User 404A, “Peter,” may input search keywords 702, 704, 705 that are search words or queries that do not include personal data of user 404A. Rendered URLs 708 may consider search keywords 702, 704, 705 as well as contextual information 712 received from the personal characteristics repository 334 of FIG. 5. User 404B, “Lisa,” may input search keywords 702, 704, 705 corresponding to search keywords 502 of FIG. 5, such as “female” and “casual sneakers,” and the system may re-rank returned URLs 706, corresponding to traditional search results 506B of FIG. 5, as rendered URLs 708. User 404B, “Lisa,” may input search keywords 702, 704, 705 that are search words or queries that do not include personal data of user 404B. Rendered URLs 708B may consider search keywords 702, 704, 705 as well as contextual information 712 received from the personal characteristics repository 334 of FIG. 5. Returned URLS 706 may be identical for both user 404A and user 404B, while rendered URLS 708A and 708B may be re-ranked differently with respect to user 404A and user 404B.

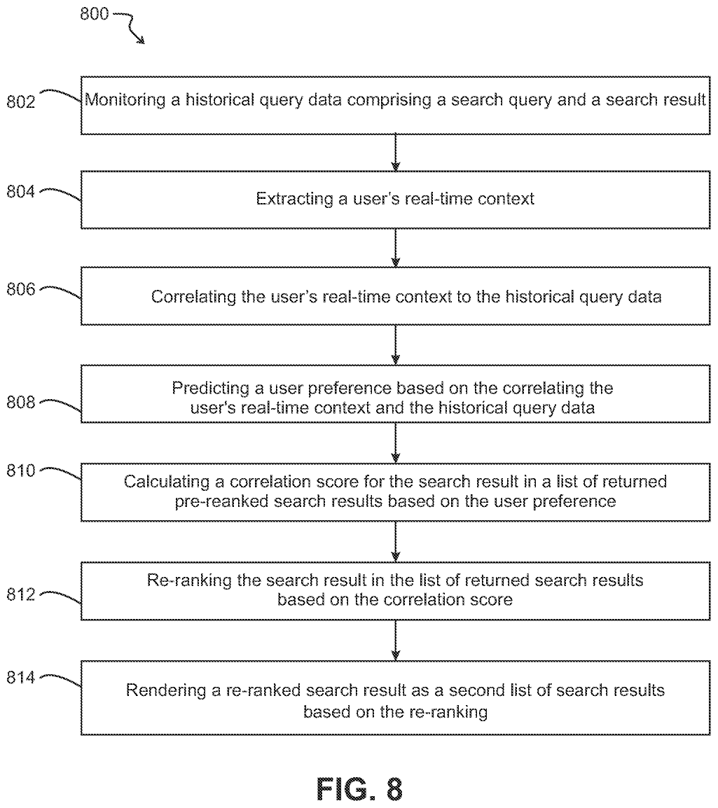

FIG. 8 shows a flowchart of an exemplary method 800 in accordance with aspects of the present invention. The method may include, as step 802, monitoring historical query data comprising a search query and a search result via the PST-bot 302 of FIG. 3. Monitoring historical query data may include a web history crawler, retrieving data from a user device including keyboard inputs and device inputs, or a search history crawler configured to collect user data. The method may include, as step 804, extracting a user's real-time context via the context extractor module 314 of FIGS. 2 and 3. Extracting a user's real-time context via the context extractor module 314 may include gathering computing device time and location data. The method may include, as step 806, correlating the user's real-time context to historical query data via the correlation analyzer module 336 of FIG. 3. Correlating the user's real-time context to a historical query data to identify users' immediate needs via the correlation analyzer module 336 may occur via word correlation, ML or NLP performed by the machine learning module 319 of FIG. 3. The method may include, as step 808, predicting a user preference based on the correlating the user's real-time context and the historical query data via preference indicator module 326 of FIG. 3 and via ML or NLP performed by the machine learning module 319 of FIG. 3. User preferences may be predicted via ML or NLP of data within user profiles 322 or personal characteristics stored in the personal characteristics repository 334. The method may include, as step 810, calculating a correlation score for the search result in a list of returned pre-ranked search results based on the user preference via the correlation analyzer module 336 of FIG. 3. The correlation score may be calculated based on similarities between the search words and contextual information and the predicted user preferences. The method may include, as step 812, re-ranking the search result in the list of returned search results based on the correlation score via the re-ranking module 342 of FIG. 3. The method may include, as step 814, rendering a re-ranked search result as a second list of search results based on the re-ranking via the result rendering agent module 330 of FIG. 3.

In embodiments, a service provider could offer to perform the processes described herein. In this case, the service provider can create, maintain, deploy, support, etc., the computer infrastructure that performs the process steps in accordance with aspects of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, implementations provide a computer-implemented method, via a network. In this case, a computer infrastructure, such as computer 101 of FIG. 1, can be provided and one or more systems for performing the processes in accordance with aspects of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes in accordance with aspects of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
monitoring, by a processor set, historical query data comprising a search query and a search result;
extracting, by the processor set, a user's real-time context;
correlating, by the processor set via a machine learning module, the user's real-time context to the historical query data;
predicting, by the processor set via the machine learning module, a user preference based on the correlating the user's real-time context to the historical query data;
calculating, by the processor set, a correlation score for the search result in a list of returned search results based on the user preference;
re-ranking, by the processor set, the search result in the list of returned search results based on the correlation score; and
rendering, by the processor set, a re-ranked search result as a second list of search results based on the re-ranking.

2. The computer-implemented method of claim 1, wherein the user's real-time context comprises a user's age, gender, family members and relations, personal preferences, search history, browsing behavior, location data, time data, and human-computer interaction patterns.

3. The computer-implemented method of claim 2, further comprising adjusting the user's real-time context based on user feedback.

4. The computer-implemented method of claim 1, wherein the historical query data comprises search keywords, selected uniform resource locators in the list of returned search results, daily web surfing history, real-time user interactions, social media account data, voice recordings, video recordings, and internet of things sensor data.

5. The computer-implemented method of claim 1, wherein the predicting the user preference comprises learning, via natural language processing, a personal characteristic of the user associated with topics under different contexts associated with the user's searching and clicking patterns.

6. The computer-implemented method of claim 1, wherein the predicting the user preference comprises performing sentiment analysis, topic modeling, user profiling, or collaborative filtering of the user's real-time context and historical query data.

7. The computer-implemented method of claim 1, further comprising:
determining a user profile based on the historical query data and the user's real-time context; and
updating the user profile based on the user preference.

8. The computer-implemented method of claim 1, wherein the correlating the user's real-time context to the historical query data occurs via word correlation, machine learning, or natural language processing.

9. The computer-implemented method of claim 1, wherein the correlating the user's real-time context to the historical query data comprises comparing contextual data to the historical query data to identify patterns in a behavior of the user and the user preference with respect to specific times and locations.

10. The computer-implemented method of claim 1, wherein the search query does not include personal data of a user.

11. A computer program product comprising one or more computer readable storage media having program instructions collectively stored on the one or more computer readable storage media, the program instructions executable to:
monitor historical query data comprising a search query and a search result;
extract a user's real-time context;
correlate, via a machine learning module, the user's real-time context to the historical query data;
predict, via the machine learning module, a user preference based on the correlating the user's real-time context to the historical query data;
calculate a correlation score for the search result in a list of returned search results based on the user preference;
re-rank the search result in the list of returned search results based on the correlation score; and
render a re-ranked search result as a second list of search results based on the re-ranking.

12. The computer program product of claim 11, wherein the user's real-time context comprises a user's age, gender, family members and relations, personal preferences, search history, browsing behavior, location data, time data, and human-computer interaction patterns.

13. The computer program product of claim 12, wherein the program instructions are executable to: adjust the user's real-time context based on user feedback.

14. The computer program product of claim 11, wherein the historical query data comprises search keywords, selected uniform resource locators in the list of returned search results, daily web surfing history, real-time user interactions, social media account data, voice recordings, video recordings, and internet of things sensor data.

15. The computer program product of claim 11, wherein the predicting the user preference comprises learning, via natural language processing, a personal characteristic of the user associated with topics under different contexts associated with the user's searching and clicking patterns.

16. The computer program product of claim 11, wherein the predicting the user preference comprises performing sentiment analysis, topic modeling, user profiling, or collaborative filtering of the user's real-time context and historical query data.

17. The computer program product of claim 11, wherein the program instructions are executable to:
determine a user profile based on the historical query data and the user's real-time context; and
update the user profile based on the user preference.

18. The computer program product of claim 11, wherein the correlating the user's real-time context to the historical query data occurs via word correlation, machine learning, or natural language processing.

19. The computer program product of claim 11, wherein the correlating the user's real-time context to the historical query data comprises comparing contextual data to the historical query data to identify patterns in a behavior of the user and the user preference with respect to specific times and locations.

20. A system comprising:
a processor set, one or more computer readable storage media, and program instructions collectively stored on the one or more computer readable storage media, the program instructions executable to:
monitor historical query data comprising a search query and a search result;
extract a user's real-time context;
correlate, via a machine learning module, the user's real-time context to the historical query data;
predict, via the machine learning module, a user preference based on the correlating the user's real-time context to the historical query data;
calculate a correlation score for the search result in a list of returned search results based on the user preference;
re-rank the search result in the list of returned search results based on the correlation score; and
render a re-ranked search result as a second list of search results based on the re-ranking.
